(19) United States
(12) Patent Application Publication
(10) Pub. No.: US 2007/0146425 A1
(43) Pub. Date: Jun. 28, 2007

(54) Ink jet apparatus and ink jetting method

(75) Inventor: Sang-mi Hong, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/641,924

(22) Filed: Dec. 18, 2006

(30) Foreign Application Priority Data
Dec. 22, 2005 (KR) 2005-0128062

(51) Int. Cl. B41J 2/15

(52) U.S. Cl. 347/40

(57) ABSTRACT

An ink jet apparatus, includes a stage comprising a seat area to which a substrate is seated, a nozzle head comprising a plurality of nozzles, a driving part relatively moving the nozzle head and the stage to each other along a first path traversing between a first area and a second area in a first direction, and a second path traversing between the first area and the second are in a second direction opposite to the first direction, and a nozzle maintaining part interposed between the nozzle head and the stage while the nozzle head and the stage relatively move along one of the first path and the second path. Thus, the present invention provides an ink jet apparatus and an ink jetting method allowing a plurality of nozzle heads to have an optimal function.

### CROSS-REFERENCE TO RELATED APPLICATIONS

This application claims priority from Korean Patent Application No.2005-0128062, filed on Dec. 22, 2005, in the Korean Intellectual Property Office, the disclosure of which is incorporated herein by reference.

### FIELD OF THE INVENTION

The present invention relates to an ink jet apparatus and an ink jetting method, and more particularly, to an ink jet apparatus and an ink jetting method allowing a nozzle head to be maintained in optimum condition.

### DESCRIPTION OF THE RELATED ART

Recently, a flat panel display apparatus such as an LCD (liquid crystal display) includes an LCD panel having a first substrate formed with a thin film transistor, a second substrate formed with a color filter and facing the first substrate, and a liquid crystal layer interposed therebetween. The organic light emitting display (OLED) comprises a plurality of organic layers and has various advantages such as low power driving, light weight, slim size, wide viewing angle, high response speed, etc. The OLED can have either a passive matrix or an active matrix. The active matrix type has a complicated manufacturing process, but can be made in large sizes and have high resolution. The various organic layers include a color filter layer, an organic semiconductor layer, a light emitting layer, an alignment layer, etc.

Recently, the organic layers have been formed by an ink jet apparatus. When a large-sized substrate is manufactured by an ink jet apparatus, the ink jet apparatus includes a plurality of nozzle heads to reduce manufacturing time. The nozzle heads are mounted to a head main body to move together, and each has a plurality of nozzles.

However, when the ink jet apparatus patterns an organic layer, some nozzle heads or some nozzles of the same nozzle head may not be used all the time. When nozzles are not used continuously, the nozzles may become obstructed affecting the reliability of the nozzles operation. Also, since the nozzles are selectively used, it is difficult for all nozzles to be managed uniformly.

### SUMMARY OF THE INVENTION

Accordingly, it is an aspect of the present invention to provide an ink jet apparatus and an ink jetting method allowing a plurality of nozzle heads to have an optimal function. The present invention provides an ink jet apparatus, comprising a stage comprising a seat area to which a substrate is seated, a nozzle head comprising a plurality of nozzles, a driving part moving the nozzle head and the stage relative to each other along a first path traversing between a first area and a second area in a first direction, and a second path traversing between the first area and the second are in a second direction opposite to the first direction, and a nozzle maintaining part interposed between the nozzle head and the stage while the nozzle head and the stage relatively move along one of the first path and the second path.

According to the embodiment of the present invention, the driving part moves the stage along the first path and the second path, and moves the nozzle head in a third direction traverse to the first direction and a fourth direction perpendicular to the first direction and the third direction.

According to the embodiment of the present invention, the ink jet apparatus further comprises a maintaining driving part positioning the nozzle maintaining part outside the seat area while the stage moves along one of the first path and the second path, and moving the nozzle maintaining part over the stage while the nozzle head moves in the third direction for moving the stage along the other of the first path and the second path.

According to the embodiment of the present invention, the nozzle head and the stage are further distanced each other when the nozzle maintaining part is interposed between the nozzle head and the stage than when the nozzle maintaining part is positioned outside the seat area.

According to the embodiment of the present invention, the ink jet apparatus further comprises an ink supplying part jetting ink through the nozzle head, and an ink supplying controller controlling the ink supplying part so that some nozzles jet ink while the stage moves along one of the first path and the second path, and all nozzles jet ink while the stage moves along the other of the first path and the second path.

Accordingly, it is an aspect of the present invention to provide an ink jetting method, comprising seating a substrate on a stage, jetting ink on the substrate with moving relatively a nozzle head comprising a plurality of nozzles and the stage to each other along a first path traversing between a first area and a second area in a first direction, stopping jetting ink and moving relatively the nozzle head and the stage to each other in a third direction traverse to the first direction, disposing a nozzle maintaining part over the stage, and jetting ink on the nozzle maintaining part with moving relatively the nozzle head and the stage to each other along a second path traversing between the first area and the second area in a second direction opposite to the first direction.

### BRIEF DESCRIPTION OF THE DRAWINGS

The above and/or other aspects and advantages of the prevent invention will become apparent and more readily appreciated from the following description of the exemplary embodiments, taken in conjunction with the accompany drawings, in which:

FIGS. 1a and 1b illustrate a first state of an ink jet apparatus according to a first embodiment of the present invention;

FIGS. 2a and 2b illustrate a second state of the ink jet apparatus according to the first embodiment of the present invention;

FIG. 3a is a control block diagram for the ink jet apparatus according to the first embodiment of the present invention;

FIG. 3b is a bottom view illustrating a nozzle head in FIG. 3a;

FIG. 4 illustrates an ink jet apparatus according to a second embodiment of the present invention;

FIG. 5 illustrates an ink jet apparatus according to a third embodiment of the present invention; and

FIG. 6 illustrates an ink jet apparatus according to a fourth embodiment of the present invention.

### DETAILED DESCRIPTION

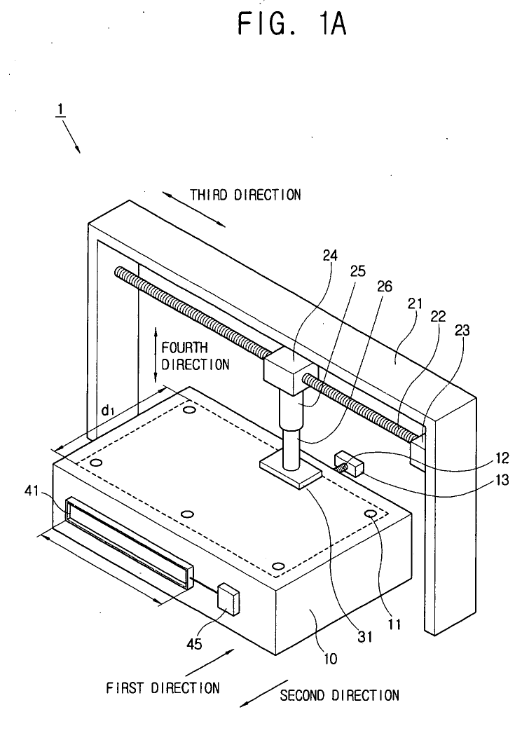

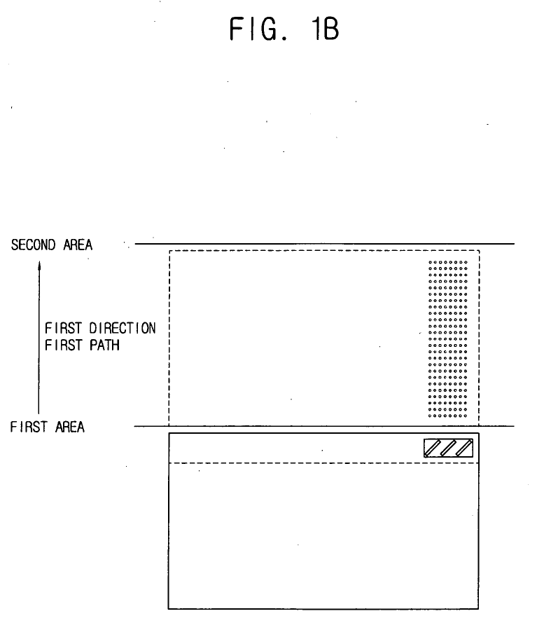

As shown in FIGS. 1a to 3b, an ink jet apparatus 1 according to a first embodiment of the present invention includes a stage 10, a plurality of nozzle heads 32 disposed over stage 10 and provided with a plurality of nozzles 33 jetting ink, and a nozzle maintaining part 41 provided to a side of stage 10.

Nozzle heads 32 and stage 10 can move relative to each other in a first direction and a second direction, and a third direction perpendicular to the first and second directions. Ink jet apparatus 1 includes a first driving part 23 moving nozzle heads 32 in the third direction, and a second driving part 13 moving stage 10 in the first and second directions.

Stage 10 is formed in a rectangular shape, and provides a seat area on which a substrate is seated in patterning an organic layer. Stage 10 is provided with a vacuum chuck 11 holding the seated substrate thereto.

Alternatively, stage 10 may be provided with an electrostatic chuck or other holding means.

Stage 10 is connected to the second driving part 13 through a second rotation member 12. The second rotation member 12 is rotated in clockwise and counterclockwise directions by means of the second driving part 23, and stage 10 moves to and fro in the first and second directions parallel to a short side of stage 10 by means of the rotation of the second rotation member 12. The second driving part 13 may include a motor. The ink jet apparatus 1 may include a rail allowing stage 10 to move smoothly.

A supporting main body 21 is provided in a reverse-U shape over stage 10 to support head main body 31. Nozzle heads 32 are mounted to the head main body 31. The supporting main body 21 extends transversely to the second direction.

A first rotation member 22 is provided to the supporting main body 21. An end of the first rotation member 22 is rotatably coupled to a first side of the supporting main body 21, and the other end thereof is connected to the first driving part 23 coupled to a second side of the supporting main body 21. A moving part 24 is interlocked, for example screw-combined, to the first rotation member 22, and moves to and fro in the third direction by means of the rotation of the first rotation member 22.

The head main body 31 is coupled to the moving part 24 to move together therewith in the third direction. Accordingly, the head main body 31 moves transversely with respect to the motion of stage 10.

The head main body 31 is coupled to moving part 24 through third driving part 25 and connecting part 26. The third driving part 25 expands and contracts so that the head main body 31 reciprocates in a fourth direction that is vertical to a surface of stage 10. Accordingly, the head main body 31 can approach and withdraw from stage 10.

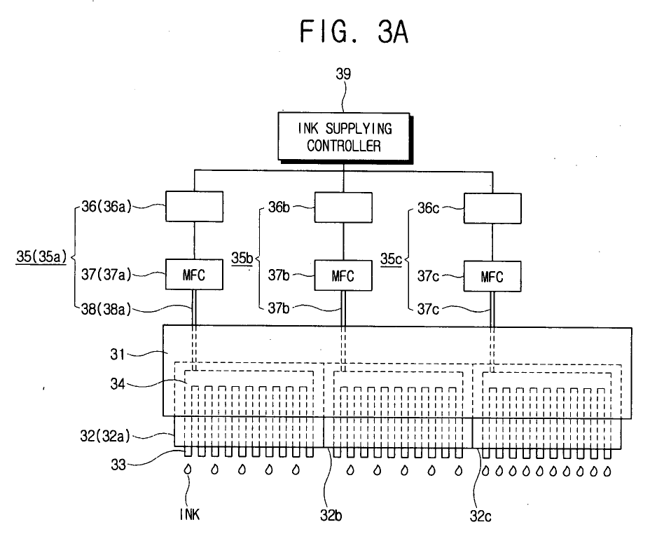

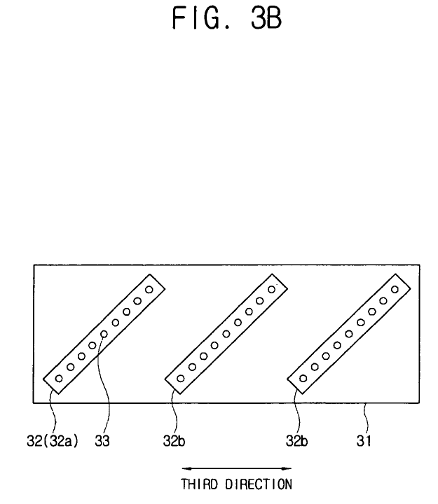

Referring to FIGS. 3a and 3b, the head main body 31 is formed in a rectangular shape elongated in the third direction. The nozzle head 32 includes three sub nozzle heads 32a, 32b and 32c. The respective nozzle heads 32 are mounted to the head main body 31 to have an angle with respect to the third direction. The angle may be adjusted according to a pattern which the ink jet apparatus 1 forms.

A plurality of nozzles 33 are arranged in a line on each nozzle head 32. The respective nozzle heads 32 are supplied with ink by a separate ink supplying part 35. The ink supplying part 35 includes an ink tank 36 storing the ink, a mass flow controller 37 controlling the amount of ink flow, and a flow pipe 38 connecting the ink tank 36 with the head main body 31. The ink supplying part 35 includes three sub ink supplying parts 35a, 35b and 35c respectively supplying ink to the sub nozzle heads 32a, 32b and 32c respectively connected thereto. The ink tank 36, the mass flow controller 37 and the flow pipe 38 respectively include three sub ink tanks 36a, 36b and 36c, three sub mass flow controllers 37a, 37b and 37c, and three sub flow pipes 38a, 38b and 38c.

The ink jet apparatus 1 further includes an ink supplying controller 39 independently controlling the respective nozzles 33 to jet ink. The ink supplying controller 39 may control the ink supplying part 35 so that odd numbered ones of nozzles 33 jet ink, referring to the first sub nozzle head 32a or even numbered ones of nozzles 33 jet ink, referring to the second sub nozzle head 32b. Alternatively, the ink supplying controller 39 may control the ink supplying part 35 so that all nozzles 33 jet ink referring to the third sub nozzle head 32c. Also, alternatively, the ink supplying controller 39 may independently control the sub ink supplying parts 35a, 35b and 35c so that some nozzle heads 32 jet ink and other nozzle heads 32 stop jetting ink.

The sub ink supplying part 35a, 35b and 35c may respectively supply a different amount of ink or the same amount of ink.

Ink supplied to the head main body 31 through the flow pipe 38 is supplied to the nozzles 33 through a flow channel 34 provided in the head main body 31 and the nozzle head 32.

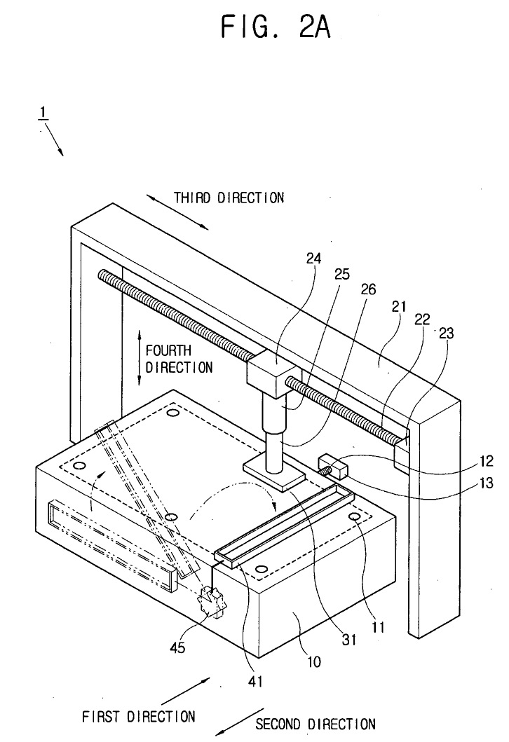

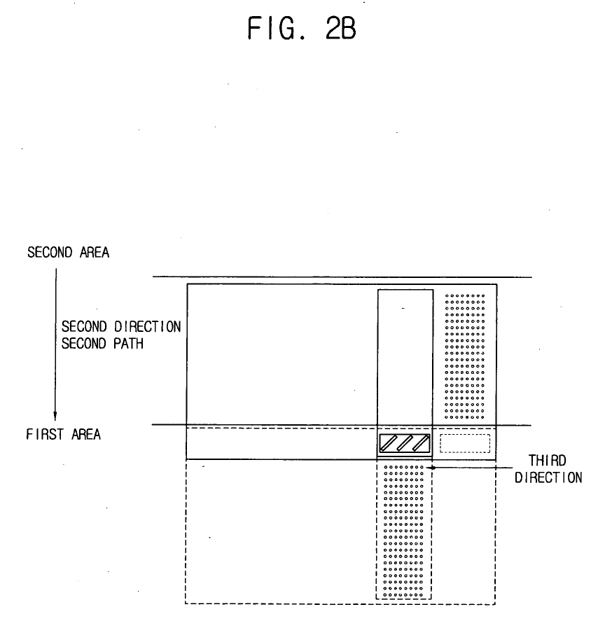

Referring to FIGS. 1a to 2b again, the nozzle maintaining part 41 is provided to a side of stage 10. The nozzle maintaining part 41 is provided as a container like a spittoon to accommodate ink jetted. Alternatively, the nozzle maintaining part 41 may be provided as a fabric absorbing ink jetted.

Stage 10 moves between a first area and a second area, and the nozzle head 32 moves in the third direction traverse to the motion of stage 10. Stage 10 moves along a first path traversing between the first area and the second area in the first direction shown in FIG. 1b, and a second path traversing between the second area and the first area in the second direction opposite to the first direction shown in FIG. 2b. A first state refers to that stage 10 moves along the first path, and a second state refers to that stage 10 moves along the second path. Referring to FIGS. 1b and 2b, solid line refers to the position of stage 1 0 before moving, and dotted line refers to the position thereof after moving. The nozzle head 32 jets ink to a substrate seated on stage 10 while stage 10 moves along the first path referring to FIG. 1b, and then moves in the third direction referring to FIG. 2b.

While stage 10 moves along the first path, the nozzle maintaining part 41 is held to the side of stage 10 to be positioned out of the seat area. Thus, while stage 10 moves along the first path, ink can be jetted through the nozzles 33 to the substrate seated on stage 10. At this time, the ink supplying controller 39 may control the ink supplying part 35 so that nozzles 33 that are odd numbered or even numbered jet ink.

In the case that some nozzles 33 jet ink, the other nozzles 33 may be obstructed. Accordingly, the other nozzles 33 do not have a normal condition, and not to thereby jet ink smoothly later.

Referring to FIG. 2a, while the nozzle head 32 moves in the third direction, the nozzle maintaining part 41 positioned to the side of stage 10 moves to be positioned between stage 10 and the nozzle head 32 by means of a maintaining driving part 45. The maintaining driving part 45 moves the nozzle maintaining part 41 in a vertical direction from the original position, and then seats the nozzle maintaining part 41 on the substrate to have a predetermined distance therebetween. The maintaining driving part 45 may include a driving gear, a hinge part and other means for moving the nozzle maintaining part 41. The maintaining driving part 45 may move the nozzle maintaining part 41 in the third direction to correspond to the motion of the nozzle head 32.

If the nozzle maintaining part 41 is seated, the nozzle head 32 is moved in a fourth direction perpendicular to the first and third directions. For example, in the case that stage 10 moves along the first path with being distanced about 500 μm from the nozzle head 32, the nozzle head 32 may be moved in the fourth direction to be further distanced 1˜2 mm from stage 10 so that the nozzle maintaining part 41 is inserted therebetween. It is preferable for the nozzle head 32 to be moved sufficiently so that the nozzle maintaining part 41 does not contact with the nozzle head 32 when stage 10 moves.

The nozzle maintaining part 41 is formed in a rectangular shape, and extends at least to correspond to a short side d1 of a substrate, and preferably, to correspond to a short side of stage 10, that is the length of stage 10 in the first path or the second path. It is preferable for the width of the nozzle maintaining part 41 to correspond to a length which the nozzles 33 are arranged, that is, the length of the nozzle head 32. If the nozzle maintaining part 41 is positioned over stage 10, the nozzle maintaining part 41 moves along the second path together with stage 10, and the nozzle head 32 jets ink to the nozzle maintaining part 41. In one way jetting, the nozzle head 32 does not jet ink while stage 10 moves along the second path, and accordingly, the nozzles 33 may be obstructed or a jetting ability thereof may be deteriorated during moving of stage 10. Thus, while stage 10 moves along the second path, the nozzle head 32 can jet ink to the nozzle maintaining part 41 positioned over a substrate, thereby maintaining the nozzles 33 in an optimum. It is preferable for all nozzles 33 provided to the nozzle head 32 to jet ink while stage 10 moves along the second path.

The nozzles 33 may jet ink containing some solvent or all solvent. Also, the nozzles 33 may jet other material as long as it can be jetted through the nozzles 33 to maintain the nozzles 33 optimally.

Stage 10 moves in the first and second directions, but alternatively, the head main body 31 may move in the first and second directions. Also, as long as stage 10 and the head main body 31 can move relatively to each other, the ink jet apparatus 1 may have other configurations. Also, the nozzle maintaining part 41 may be coupled to other sides of stage 10, or may not be coupled thereto. As long as the nozzle maintaining part 41 can accommodate ink or other material jetted from the nozzle head 32, the nozzle maintaining part 41 can be disposed to other positions to be inserted between the nozzle head 32 and a substrate while stage 10 moves along the second path. A plurality of nozzle maintaining parts 41 may be provided according to the size of stage 10.

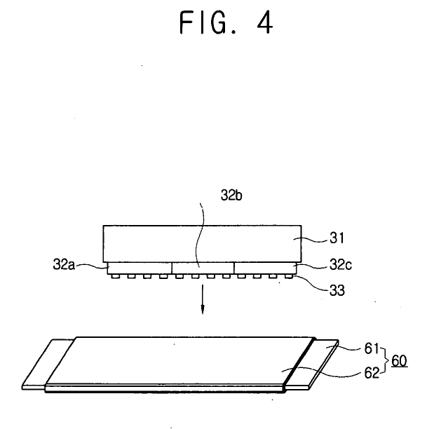

As shown in FIG. 4, an ink jet apparatus according to a second embodiment of the present invention includes a blotting stage 60 having a plate 61 or a bar and an absorbing member 62 winding the plate 61. The blotting stage 60 is provided as a nozzle maintaining part, and the absorbing member 62 may be formed of a fabric having good absorbing ability with respect to ink.

A head main body 31 is moved over the blotting stage 60 so that nozzles 33 provided to the head main body 31 contact with the absorbing member 62. Thus, ink stagnated inside the nozzles 33 can be absorbed by the absorbing member 62, and new ink can be supplied to the nozzles 33. Also, ink stained around the nozzles 33 can be absorbed to be cleaned. Accordingly, the nozzles 33 can be maintained to have an optimal condition.

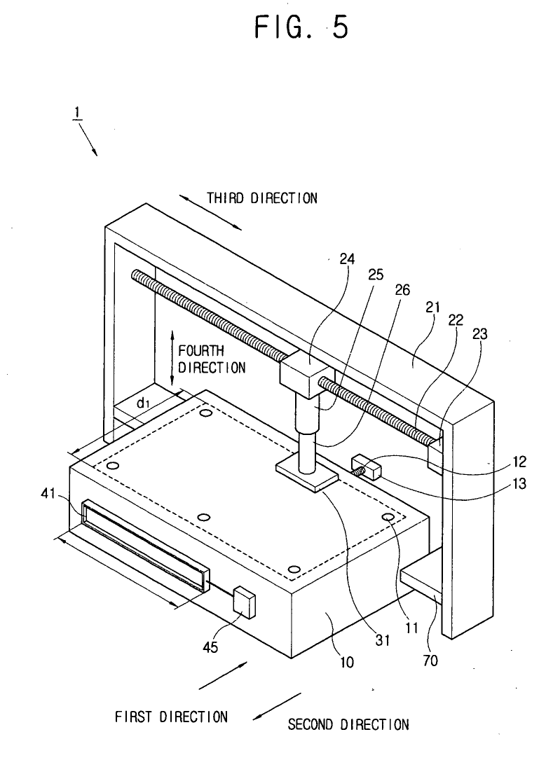

As shown in FIG. 5, an ink jet apparatus according to a third embodiment of the present invention includes an additional nozzle maintaining part 70 disposed to opposite sides of a supporting main body 21. The nozzle maintaining part 70 may be provided as a container like a spittoon or a blotting stage. Also, the nozzle maintaining part 70 may be provided as a capping station fixedly coupled to the supporting main body 21 and containing a solvent. Nozzles 33 may move to the nozzle maintaining part 70 during alternating between a first path and a second path. At this time, a stage 10 and a nozzle head 32 can relatively move to each other in a third direction so as to maintain the function of the nozzles 33.

In the case that the nozzle maintaining part 70 is provided as a capping station, the nozzles 33 are dipped into a solvent contained in the capping station. Accordingly, the solvent is permeated into the nozzles 33, and prevents ink inside the nozzles 33 from drying, and to thereby prevent the nozzles 33 from being obstructed.

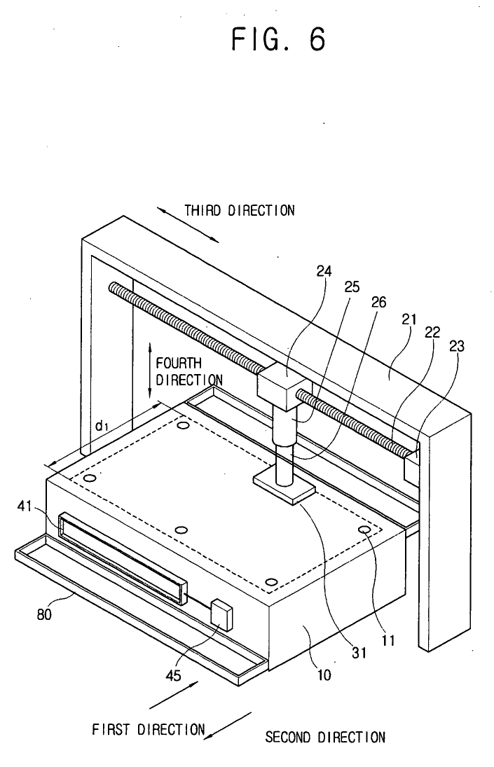

As shown in FIG. 6, an ink jet apparatus according to a fourth embodiment of the present invention includes a couple of spittoon parts 80 disposed beside a stage 10. The spittoon parts 80 are formed to contain ink. Alternatively, the spittoon parts 80 may be formed of a fabric absorbing ink. The spittoon parts 80 extend along a third direction, and interpose stage 10 therebetween. The spittoon parts 80 are coupled to stage 10 to alternate together with stage 10. The spittoon parts 80 contact with stage 10, and are extended so that the end parts thereof protrude from the stage.

The ink jet apparatus and the ink jetting method according to the present invention may be applied to a manufacture of an OLED apparatus or other display apparatus.

Also, the ink jet apparatus and the ink jetting method may be applied to a manufacture of an organic TFT substrate, an OLED including an organic TFT substrate, and an LCD.

Also, the ink jet apparatus and the ink jetting method may be applied to a manufacture of a color filter substrate. Here, an alignment film or a color filter layer may be formed by the ink jet apparatus and the ink jetting method thereof.

As described above, the present invention provides an ink jet apparatus and an ink jetting method allowing a plurality of nozzle heads to have an optimal function.

Although a few exemplary embodiments of the present invention have been shown and described, it will be appreciated by those skilled in the art that changes may be made in these embodiments without, however, departing from the principles and spirit of the invention.

What is claimed is:

1. An ink jet apparatus, comprising:
a stage comprising a seat area for receiving a substrate;
a nozzle head comprising a plurality of nozzles;
a driving part moving the nozzle head and the stage relatively to each other along a first path traversing between a first area and a second area in a first direction, and a second path traversing between the first area and the second are in a second direction opposite to the first direction; and
a nozzle maintaining part interposed between the nozzle head and the stage while the nozzle head and the stage relatively move along one of the first path and the second path.

2. The ink jet apparatus according to claim 1, wherein the driving part moves the stage along the first path and the second path, and moves the nozzle head in a third direction traverse to the first direction and a fourth direction perpendicular to the first direction and the third direction.

3. The ink jet apparatus according to claim 2, further comprising a maintaining driving part positioning the nozzle maintaining part outside the seat area while the stage moves along one of the first path and the second path, and moving the nozzle maintaining part over the stage while the nozzle head moves in the third direction for moving the stage along the other of the first path and the second path.

4. The ink jet apparatus according to claim 3, wherein the nozzle head and the stage are further distanced from each other when the nozzle maintaining part is interposed between the nozzle head and the stage than when the nozzle maintaining part is positioned outside the seat area.

5. The ink jet apparatus according to claim 3, further comprising:
an ink supplying part jetting ink through the nozzle head; and
an ink supplying controller controlling the ink supplying part so that some nozzles jet ink while the stage moves along one of the first path and the second path, and all nozzles jet ink while the stage moves along the other of the first path and the second path.

6. The ink jet apparatus according to claim 5, wherein some odd-numbered and some even numbered nozzles jet ink.

7. The ink jet apparatus according to claim 5, wherein some nozzles jet ink to the substrate.

8. The ink jet apparatus according to claim 5, wherein all nozzles jet ink to the nozzle maintaining part.

9. The ink jet apparatus according to claim 1, further comprising:
an ink supplying part jetting ink through the nozzle head; and
an ink supplying controller controlling the ink supplying part so that some nozzles jet ink while the nozzle head and the stage relatively move to each other along one of the first path and the second path, and all nozzles jet ink while the nozzle head and the stage relatively move to each other along the other of the first path and the second path.

10. The ink jet apparatus according to claim 9, wherein the nozzle maintaining part is positioned outside the seat area when some nozzles jet ink, and the nozzle maintaining part is interposed between the nozzle head and the stage when all nozzles jet ink.

11. The ink jet apparatus according to claim 1, wherein the nozzle maintaining part is formed in a rectangular shape, and extends corresponding to the length of the first path or the second path in a lengthwise direction thereof.

12. The ink jet apparatus according to claim 11, wherein the nozzle maintaining part has a width to correspond to at least a length which the nozzles are arranged.

13. The ink jet apparatus according to claim 11, wherein the stage is formed in a quadrangular pillar, and the nozzle maintaining part is coupled to a side of the stage.

14. The ink jet apparatus according to claim 13, further comprising a maintaining driving part coupling the nozzle maintaining part to the side of the stage while the stage and the nozzle head relatively move along one of the first path and the second path, and moving the nozzle maintaining part to be interposed between the nozzle head and the stage before the stage and the nozzle head relatively move along the other of the first path and the second path.

15. The ink jet apparatus according to claim 1, wherein the nozzle maintaining part comprises at least one of a spittoon containing ink jetted, a capping station containing a solvent, and a blotting stage provided with an absorbing member.

16. The ink jet apparatus according to claim 1, further comprising an additional nozzle maintaining part positioned outside the stage.

17. The ink jet apparatus according to claim 16, wherein a couple of additional nozzle maintaining parts are provided to interpose the stage therebetween.

18. An ink jetting method, comprising:
seating a substrate on a stage;
jetting ink on the substrate with moving relatively a nozzle head comprising a plurality of nozzles and the stage to each other along a first path traversing between a first area and a second area in a first direction;
stopping jetting ink and moving relatively the nozzle head and the stage to each other in a third direction traverse to the first direction;
disposing a nozzle maintaining part over the stage; and
jetting ink on the nozzle maintaining part with moving relatively the nozzle head and the stage to each other along a second path traversing between the first area and the second area in a second direction opposite to the first direction.

19. The ink jetting method according to claim 18, wherein ink is jetted on the substrate by some nozzles.

20. The ink jetting method according to claim 19, wherein ink is jetted by some nozzles having an odd order or an even order.

21. The ink jetting method according to claim 18, wherein ink is jetted on the nozzle maintaining part by all nozzles.

22. The ink jetting method according to claim 18, wherein the stage moves along the first path and the second path, and the nozzle head moves in the third direction and a fourth direction perpendicular to the first direction and the third direction.

23. The ink jetting method according to claim 22, wherein the nozzle maintaining part is positioned outside a seat area formed on the stage while the stage moves along one of the first path and the second path.

24. The ink jetting method according to claim 18, further comprising:
providing an additional nozzle maintaining part positioned outside the stage; and
moving the nozzle head over the additional nozzle maintaining part.
